(19) United States
(12) Patent Application Publication
(10) Pub. No.: US 2022/0336850 A1
(43) Pub. Date: Oct. 20, 2022

(54) BATTERY

(71) Applicants: TOYOTA JIDOSHA KABUSHIKI KAISHA, Toyota-shi (JP); Panasonic Holdings Corporation, Kadoma-shi (JP)

(72) Inventors: Yuhi YAMANO, Nagoya-shi (JP); Kunimitsu YAMAMOTO, Kasugai-shi (JP); Yuki ARAI, Toyota-shi (JP); Takamasa OHTOMO, Miyoshi-shi (JP); Yasunari SUGITA, Osaka-shi (JP); Tatsuya OSHIMA, Hirakata-shi (JP)

(21) Appl. No.: 17/659,114

(22) Filed: Apr. 13, 2022

(30) Foreign Application Priority Data
Apr. 20, 2021 (JP) 2021-070836

(51) Int. Cl. H01M 10/0562; H01M 10/42; H01M 4/134

(52) U.S. Cl. CPC H01M 10/0562; H01M 10/4235; H01M 4/134; H01M 2300/008

(57) ABSTRACT

A main object of the present disclosure is to provide a battery superior in safety against heating. The present disclosure achieves the object by providing a battery comprising cathode current collector, a cathode active material layer, a solid electrolyte layer, an anode active material layer, and an anode current collector, in this order along a thickness direction, and the anode current collector includes a coating layer including an oxide active material, on a surface of the anode active material layer side, the solid electrolyte layer includes a first solid electrolyte layer, and a second solid electrolyte layer placed between the first solid electrolyte layer and the anode active material layer, the first solid electrolyte layer includes a halide solid electrolyte, and the second solid electrolyte layer includes a sulfide solid electrolyte.

### TECHNICAL FIELD

The present disclosure relates to a battery.

### BACKGROUND ART

A battery including a solid electrolyte layer between a cathode active material layer and an anode active material layer has advantages in that it is easy to simplify a safety device as compared with a battery including a liquid electrolyte containing flammable organic solvents.

As an anode active material having good capacity property, a Si based active material has been known. Patent Literature 1 discloses an anode for a sulfide all solid state battery including at least one kind of the material selected from the group consisting of Si and a Si alloy, as an anode active material.

Also, although it is not a technique relating to a battery including a solid electrolyte layer, Patent Literature 2 discloses an anode for a non-aqueous electrolyte secondary battery comprising a current collector, a first layer including a lithium titanate, and a second layer including a carbon material, wherein a ratio T₁/T₂ of a thickness T₁ of the first layer and a thickness T₂ of the second layer is 0.15 or more and 0.55 or less. Also, Patent Literature 3 discloses a battery including a sulfide solid electrolyte and a halide solid electrolyte as a solid electrolyte.

### CITATION LIST

### Patent Literatures

Patent Literature 1: Japanese Patent Application Laid-Open (JP-A) No. 2018-142431

Patent Literature 2: JP-A No. 2014-199714

Patent Literature 3: WO2019-135323

### SUMMARY OF DISCLOSURE

### Technical Problem

For example, in order to reduce the heating value generated when a short circuit occurs, it is effective to provide the coating layer to be described later, between an anode current collector and an anode active material layer. Meanwhile, since a large amount of current is generated by the short circuit due to a large conductive foreign substance, for example, further improvement of the safety against heating is desired.

The present disclosure has been made in view of the above circumstances, and a main object of the present disclosure is to provide a battery superior in safety against heating.

### Solution to Problem

In order to achieve the object, the present disclosure provides a battery comprising a cathode current collector, a cathode active material layer, a solid electrolyte layer, an anode active material layer, and an anode current collector, in this order along a thickness direction, and the anode current collector includes a coating layer including an oxide active material, on a surface of the anode active material layer side, the solid electrolyte layer includes a first solid electrolyte layer, and a second solid electrolyte layer placed between the first solid electrolyte layer and the anode active material layer, the first solid electrolyte layer includes a halide solid electrolyte, and the second solid electrolyte layer includes a sulfide solid electrolyte.

According to the present disclosure, by placing the coating layer between the anode current collector and the anode active material layer, and by the first solid electrolyte layer including a halide solid electrolyte, a battery superior in safety against heating, may be provided.

In the disclosure, the oxide active material may include at least one of a lithium titanate, and a niobium titanium based oxide.

In the disclosure, the halide solid electrolyte may be represented by the following composition formula (1),

Li_{α}M_{β}X_{γ} formula (1),

α, β, and γ are respectively a value more than 0, “M” includes at least one selected from the group consisting of a metal element other than Li, and a metalloid element, and “X” includes at least one selected from the group consisting of F, Cl, Br, and I.

In the disclosure, the halide solid electrolyte may be represented by Li_{6-3A}X₆, wherein “A” satisfies 0<A<2, “M” is at least one of Y and In, and “X” is at least one of Cl and Br.

In the disclosure, the halide solid electrolyte may be a chloride solid electrolyte.

In the disclosure, the sulfide solid electrolyte may include Li, P, and S.

In the disclosure, the anode active material layer may include an anode active material whose total volume expansion rate, due to charge, is 14% or more.

In the disclosure, an anode active material may be a Si based active material.

In the disclosure, a ratio of a thickness of the coating layer with respect to a thickness of the anode active material layer may be 3% or more and 20% or less.

### Advantageous Effects of Disclosure

The battery in the present disclosure exhibits effects that the safety against heating is superior.

### BRIEF DESCRIPTION OF DRAWINGS

FIG. 1 is a schematic cross-sectional view illustrating an example of a battery in the present disclosure.

FIG. 2 is a schematic cross-sectional view illustrating an example of a battery in the present disclosure.

FIG. 3 is a schematic cross-sectional view illustrating an example of a battery in the present disclosure.

FIG. 4 is the result of a nailing test to the batteries produced in Example 1 and Comparative Examples 1 to 3.

### DESCRIPTION OF EMBODIMENTS

A battery in the present disclosure will be hereinafter described in detail referring to the drawings. Each figure shown below is schematically expressed, and the size and the shape of each member are appropriately exaggerated, to facilitate understanding. Also, in each figure, the hatching indicating the cross-section of a member is appropriately omitted.

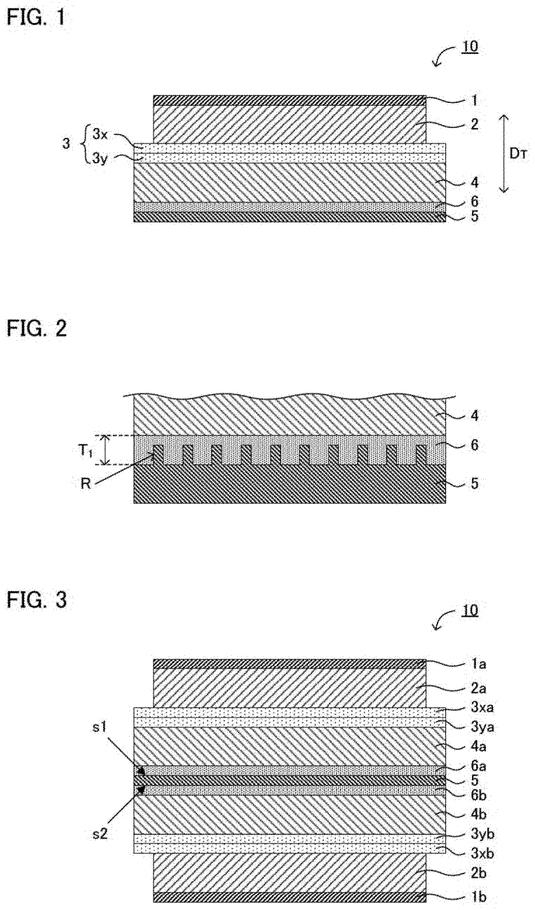

FIG. 1 is a schematic cross-sectional view illustrating an example of a battery in the present disclosure. Battery 10 shown in FIG. 1 comprises cathode current collector 1, cathode active material layer 2, solid electrolyte layer 3, anode active material layer 4, and anode current collector 5, in this order along thickness direction D_{T}. The anode current collector 5 includes coating layer 6 including an oxide active material, on a surface of the anode active material layer 4 side. Also, the solid electrolyte layer 3 includes first solid electrolyte layer 3x, and second solid electrolyte layer 3y placed between the first solid electrolyte layer 3x and the anode active material layer 4. The first solid electrolyte layer 3x includes a halide solid electrolyte, and the second solid electrolyte layer 3y includes a sulfide solid electrolyte. Incidentally, in the present disclosure, the cathode current collector 1 and the cathode active material layer 2 may be referred to as “cathode”, and the anode active material layer 4, the coating layer 6, and the anode current collector 5 may be referred to as “anode”.

According to the present disclosure, by placing the coating layer between the anode current collector and the anode active material layer, and by the first solid electrolyte layer including a halide solid electrolyte, a battery superior in safety against heating, may be provided. As described above, in order to reduce the heating value generated when a short circuit occurs, for example, it is effective to provide the coating layer including an oxide active material, between the anode current collector and the anode active material layer. When Li is intercalated, the oxide active material exhibits an electron conductivity, and when the intercalated Li is desorbed, it exhibits an insulating property. Therefore, the internal resistance increase may be suppressed by forming an electron conductive path, using the electron conductivity of the oxide active material. Meanwhile, for example, when a short circuit occurs, since Li is desorbed from the oxide active material, the heating value may be decreased by blocking the electron conductive path, using the insulating property (shutdown function) thereof.

Since a large amount of current is generated by the short circuit due to a large conductive foreign substance, for example, further improvement of the safety against heating is desired. In the present disclosure, by using a halide solid electrolyte having good heat stability as the solid electrolyte to be used for the solid electrolyte layer, the safety against heating may further be improved. Meanwhile, since the halide solid electrolyte is relatively low in reduction resistance, the halide solid electrolyte is used for first solid electrolyte layer on the cathode active material layer side, to which reduction resistance is not required. Further, the sulfide solid electrolyte having relatively high reduction resistance is used for the second solid electrolyte layer on the anode active material layer side to which reduction resistance is required. Thereby, a battery highly safety against heating, and having good cycle property may be obtained.

1. Anode

The anode in the present disclosure includes an anode active material layer, and an anode current collector. Also, the anode current collector includes a coating layer including an oxide active material, on a surface of the anode active material layer side.

(1) Coating Layer

The coating layer is a layer placed on a surface of the anode current collector, on the anode active material layer side. Further, the coating layer includes an oxide active material. The oxide active material usually has an electron conductivity under the condition wherein Li is intercalated, and has an insulating property under the condition wherein the intercalated Li is desorbed. When the electron conductivity (25° C.) of the oxide active material, under the condition wherein Li is intercalated, is regarded as C₁, and the electron conductivity (25° C.) of the oxide active material, under the condition wherein the intercalated Li is desorbed, is regarded as C₂, C₁/C₂ is, for example, 10⁴ or more, and may be 10³ or more. When C₁/C₂ is large enough, a good shutdown function may be obtained. The electron conductivity (25° C.) of the oxide active material, under the condition wherein Li is intercalated, is, for example, 8.0×10⁻¹ S/cm or more. Meanwhile, electron conductivity (25° C.) of the oxide active material, under the condition wherein the intercalated Li is desorbed, is, for example, 2.1×10⁻⁶ S/cm or less.

The oxide active material includes at least a metal element and an oxygen element. Also, the oxide active material preferably includes at least one of a layered structure and a spinel structure. An example of the oxide active material may be a lithium titanate. The lithium titanate is a compound including Li, Ti, and O, and examples thereof may include Li₄Ti₅O₁₂, Li₄TiO₄, Li₂TiO₃, and Li₂Ti₃O₇. Another example of the oxide active material may be a niobium titanium based oxide. The niobium titanium based oxide is a compound including Ti, Nb, and O, and examples thereof may include TiNb₂O₇, and Ti₂Nb₁₀O₂₉. The coating layer may include only one kind of the oxide active material, and may include two kinds or more thereof. Also the Li intercalation/desorption potential of the oxide active material is preferably higher than that of the anode active material.

Examples of the shape of the oxide active material may include a granular shape. The average particle size (D₅₀) of the oxide active material is not particularly limited; and is, for example, 10 nm or more, and may be 100 nm or more. Meanwhile, the average particle size (D₅₀) of the oxide active material is, for example, 50 μm or less, and may be 20 μm or less. The average particle size (D₅₀) may be calculated from the measurement by, for example, a laser diffraction particle size analyzer, and a scanning electron microscope (SEM). The proportion of the oxide active material in the coating layer is, for example, 50 weight % or more, may be 70 weight % or more, and may be 90 weight % or more.

The coating layer may or may not include a conductive material. By adding a small amount of the conductive material, the shutdown function is activated promptly so that the heating value may further be reduced. Examples of the conductive material may include a carbon material, a metal particle, and a conductive polymer. Examples of the carbon material may include particulate carbon materials such as acetylene black (AB) and Ketjen black (KB); and fibrous carbon materials such as carbon fiber, carbon nanotube (CNT), and carbon nanofiber (CNF).

The proportion of the conductive material in the coating layer is, for example, 1 weight % or less, may be 0.5 weight % or less, and may be 0.3 weight % or less. The proportion of the conductive material may be 0 weight %, may be more than 0 weight %, and in the latter case, it may be, for example, 0.05 weight % or more.

The coating layer may or may not include a solid electrolyte. By adding the solid electrolyte, preferable ion conductive path is formed in the coating layer so that the shutdown function is promptly activated, and the heating value may further be reduced. Meanwhile, by not adding the solid electrolyte, the internal resistance increase may be suppressed. Examples of the solid electrolyte may include inorganic solid electrolytes such as sulfide solid electrolyte, oxide solid electrolyte, nitride solid electrolyte, and halide solid electrolyte. For the sulfide solid electrolyte and the halide solid electrolyte, materials similar to the materials to be described in “2. Solid electrolyte layer” below may be used.

The proportion of the solid electrolyte in the coating layer is, for example, 5 volume % or more, and may be 10 volume % or more. When the proportion of the solid electrolyte is too low, the heating value reducing effect due to the solid electrolyte is not likely to be obtained. Meanwhile, the proportion of the solid electrolyte in the coating layer is, for example, 30 volume % or less. When the proportion of the solid electrolyte is too high, the internal resistance is likely to be increased.

The coating layer preferably includes a binder. By adding a binder, adhesiveness of the coating layer is improved, and close adhesion of the anode active material layer and the anode current collector is improved. Examples of the binder may include fluorine based binders, polyimide based binders, and rubber based binders. The content of the binder in the coating layer is, for example, 1 weight % or more and 10 weight % or less.

In the present disclosure, the thickness of the coating layer is regarded as T₁, and the thickness of the anode active material layer is regarded as T₂. The ratio (T₁/T₂) of T₁ with respect to T₂ is, for example, 3% or more, and may be 5% or more. When T₁/T₂ is too low, the heating value reducing effect is not likely to be obtained. Meanwhile, the ratio (T₁/T₂) of T₁ with respect to T₂ is, for example, 20% or less, may be 13% or less, and may be 10% or less. When T₁/T₂ is too high, the internal resistance is likely to be increased. T₁ is, for example, 2 μm or more, may be 3 μm or more, and may be 4 μm or more. Meanwhile, T₁ is, for example, 15 μm or less, and may be 10 μm or less. T₂ is, for example, 20 μm or more, and may be 40 μm or more. Meanwhile, T₂ is, for example, 200 μm or less, and may be 150 μm or less.

Also, as shown in FIG. 2, the thickness of the coating layer 6 is regarded as T₁, and the surface roughness (Rz) of the surface of the anode current collector 5, on the coating layer 6 side is regarded as “R”. Incidentally, the unit of T₁ and “R” is μm. Also, the surface roughness Rz means a ten-point average roughness, and may be determined by, for example, a probe type surface roughness measuring device. The ratio (R/T₁) of “R” with respect to T₁ is, for example, 30% or more, and may be 40% or more. As R/T₁ increases, the heating value reducing effect is likely to be obtained. Meanwhile, the ratio (R/T₁) of R with respect to T₁ is, for example, less than 100%, may be 90% or less, and may be 80% or less. When R/T₁ is less than 100%, the heating value may further be reduced, since a part of the anode current collector may be suppressed from being exposed from the coating layer.

The surface roughness (Rz) of the anode current collector is, for example, 2 μm or more, may be 4 μm or more, and may be 6 μm or more. Meanwhile, the surface roughness (Rz) of the anode current collector is, for example, 9 μm or less.

(2) Anode Active Material Layer

The anode active material layer includes at least an anode active material, and may further include at least one of a solid electrolyte, a conductive material, and a binder.

The anode active material is not particularly limited, and a general anode active material may be used; among them, the total volume expansion rate, due to charge, of the anode active material is preferably 14% or more. An active material having high total volume expansion rate, due to charge, tends to have high capacity property. Also, for example, although the heating value generated when short circuit occurs tends to be high when the capacity property is high, high capacity property may be maintained while suppressing the heating value increase in the present disclosure, by providing the coating layer described above.

Here the total volume expansion rate, due to charge, of a graphite, known as a general anode active material, is 13.2% (Simon Schweidler et al., “Volume Changes of Graphite Anodes Revisited: A Combined Operando X-ray Diffraction and In Situ Pressure Analysis Study”, J. Phys. Chem. C 2018, 122, 16, 8829-8835). That is, the anode active material having total volume expansion rate, due to charge, of 14% or more is an active material whose total volume expansion rate, due to charge, is larger than the graphite. As Simon Schweidler et al. describes, the total volume expansion rate due to charge may be determined by a space-group-independent evaluation. The total volume expansion rate due to charge of the anode active material may be 100% or more, and may be 200% or more.

An example of the anode active material may include a Si based active material. The Si based active material is an active material including a Si element. Examples of the Si based active material may include a Si simple substance, a Si alloy, and a Si oxide. The Si alloy preferably includes a Si element as a main component. Also, other examples of the anode active material may include a Sn based active material. The Sn based active material is an active material including a Sn element. Examples of the Sn based active material may include a Sn simple substance, a Sn alloy, and a Sn oxide. The Sn alloy preferably includes a Sn element as a main component.

Examples of the shape of the anode active material may include a granular shape. The average particle size (D₅₀) of the anode active material is not particularly limited; and is for example, 10 nm or more, and may be 100 nm or more. Meanwhile, the average particle size (D₅₀) of the anode active material is, for example, 50 μm or less, and may be 20 μm or less.

The proportion of the anode active material in the anode active material layer is, for example, 20 weight % or more, may be 40 weight % or more, and may be 60 weight % or more. Meanwhile, the proportion of the anode active material is, for example, 80 weight % or less. Also, the anode active material layer may further include at least one of a solid electrolyte, a conductive material, and a binder. For these materials, materials similar to the materials in the coating layer described above, may be used.

(3) Anode Current Collector

The anode current collector is a member that corrects current of the anode active material layer. Examples of the anode current collector may include a metal current collector. Examples of the metal current collector may include a current collector including a metal such as Cu, and Ni. The metal current collector may be a simple substance of the metal, and may be an alloy of the metal. Examples of the shape of the anode current collector may include a foil shape.

2. Solid Electrolyte Layer

The solid electrolyte layer in the present disclosure is a layer placed between the cathode active material layer and the anode active material layer, and is a layer including at least a solid electrolyte. Also, the solid electrolyte layer includes a first solid electrolyte layer including a halide solid electrolyte; and a second solid electrolyte layer including a sulfide solid electrolyte. The first solid electrolyte layer is located on the cathode active material layer side, than the second solid electrolyte layer.

(1) First Solid Electrolyte Layer

The first solid electrolyte layer is a layer including at least a halide solid electrolyte as a solid electrolyte. In the present disclosure, “halide solid electrolyte” means a solid electrolyte material including a halogen element, and does not include sulfur. Also, in the present disclosure, the solid electrolyte material that does not include sulfur means a solid electrolyte material represented by a composition formula not including a sulfur element. Therefore, a solid electrolyte including a minute amount of the sulfur component, for example, 0.1 weight % or less of sulfur, is included in the solid electrolyte that does not include sulfur. The halide solid electrolyte may further include an oxygen as an anion other than the halogen element.

The first solid electrolyte layer preferably includes the halide solid electrolyte as a main component of the solid electrolyte. The reason therefor is to improve the safety against heating. The “main component of the solid electrolyte” refers to a solid electrolyte of the highest proportion in all the solid electrolyte included in the layer. The proportion of the halide solid electrolyte to all the solid electrolyte in the first solid electrolyte layer is, for example, 50 volume % or more, may be 70 volume % or more, and may be 90 volume % or more.

Also, the first solid electrolyte layer may include only the halide solid electrolyte as a solid electrolyte. Meanwhile, when the first solid electrolyte layer includes the solid electrolyte other than the halide solid electrolyte, examples of the solid electrolyte may include inorganic solid electrolytes such as a sulfide solid electrolyte, an oxide solid electrolyte, and a nitride solid electrolyte.

The halide solid electrolyte preferably includes a Li element, a metal element other than Li or a metalloid element, and a halogen element.

The halide solid electrolyte may be represented by the following composition formula (1).

Li_{α}M_{β}X_{γ} formula (1),

Here, α, β, and γ are respectively values more than 0.

“M” includes at least one selected from the group consisting of a metal element other than Li, and a metalloid element. “M” may be at least one element selected from the group consisting of a metal element other than Li, and a metalloid element. “X” includes at least one selected from the group consisting of F, Cl, Br, and I. “X” may be at least one selected from the group consisting of F, Cl, Br, and I. According to the configuration described above, the ion conductivity of the halide solid electrolyte may further be improved. Thereby, the output property of a battery may further be improved.

In the composition formula (1), α, β, and γ may satisfy 2.5≤α≤3, 1≤β≤1.1, and γ=6. According to the configuration described above, the ion conductivity of the halide solid electrolyte may further be improved.

In the present disclosure, “metalloid element” is B, Si, Ge, As, Sb, and Te. In the present disclosure, “metal element” is all the elements belonging to the groups 1 to 12 of the periodic table except hydrogen; and all the elements belonging to the groups 13 to 16 of the periodic table except B, Si, Ge, As, Sb, Te, C, N, P, O, S, and Se. That is, “metalloid element” or “metal element” refers to an element group that may be a cation when an inorganic compound is formed with the halogen compound.

In the composition formula (1), “M” may include Y (yttrium). That is, the halide solid electrolyte may include Y as the metal element. According to the configuration described above, the ion conductivity of the halide solid electrolyte may further be improved.

The halide solid electrolyte including Y may be a compound represented by a composition formula, for example, LiₐMe_{b}Y_{c}X₆. Here, “a”, “b”, and “c” satisfy a+mb+3c=6, and c>0. “Me” is at least one selected from the group consisting of a metal element except Li and Y, and a metalloid element. The “m” is valence of “Me”. “X” is at least one selected from the group consisting of F, Cl, Br and I. “Me” may be at least one selected from the group consisting of Mg, Ca, Sr, Ba, Zn, Sc, Al, Ga, Bi, Zr, Hf, Ti, Sn, Ta and Nb. According to the configuration described above, the ion conductivity of the halide solid electrolyte may further be improved.

The halide solid electrolyte may be represented by the following composition formula (A1).

Li_{6-3d}Y_{d}X₆ formula (A1)

In the composition formula (A1), “X” is at least one selected from the group consisting of F, Cl, Br and I, or two kinds or more of the elements selected from the group. In the composition formula (Al), “d” satisfies 0<d<2. According to the configuration described above, the ion conductivity of the halide solid electrolyte may further be improved.

The halide solid electrolyte may be represented by the following composition formula (A2).

Li₃YX₆ formula (A2)

In the composition formula (A2), “X” is at least one selected from the group consisting of F, Cl, Br and I, or two kinds or more of the elements selected from the group. According to the configuration described above, the ion conductivity of the halide solid electrolyte may further be improved.

The halide solid electrolyte may be represented by the following composition formula (A3).

Li_{3-3δ}Y_{1+δ}Cl₁₆ formula (A3)

In the composition formula (A3), δ satisfies 0<δ≤0.15. According to the configuration described above, the ion conductivity of the halide solid electrolyte may further be improved.

The halide solid electrolyte may be represented by the following composition formula (A4)

Li_{3-3δ}Y_{1+δ}Br₆ formula (A4)

In the composition formula (A4), δ satisfies 0<δ≤0.25. According to the configuration described above, the ion conductivity of the halide solid electrolyte may further be improved.

The halide solid electrolyte may be represented by the following composition formula (A5).

Li_{3-3δ+a}Y_{1+δ-a}MeₐCl_{6-x-y}BrₓI_{y} formula (A5)

In the composition formula (A5), “Me” includes at least one selected from the group consisting of Mg, Ca, Sr, Ba, and Zn. “Me” may be at least one selected from the group consisting of Mg, Ca, Sr, Ba, and Zn. In the composition formula (A5), “δ”, “a”, “x” and “y” satisfy −1<δ<2, 0<a<3, 0<(3−3δ+a), 0<(1+δ−a), 0≤x≤6, 0≤y≤6, and (x+y)≤6. According to the configuration described above, the ion conductivity of the halide solid electrolyte may further be improved.

The halide solid electrolyte may be represented by the following composition formula (A6).

Li_{3-3δ}Y_{1+δ-a}MeₐCl_{6-x-y}BrₓI_{y} formula (A6)

In the composition formula (A6), “Me” includes at least one selected from the group consisting of Al, Sc, Ga, and Bi. “Me” may be at least one selected from the group consisting of Al, Sc, Ga, and Bi. In the composition formula (A6), “δ”, “a”, “x” and “y” satisfy −1<δ<1, 0<a<2, 0<(1+δ−a), 0≤x≤6, 0≤y≤6, and (x+y)≤6. According to the configuration described above, the ion conductivity of the halide solid electrolyte may further be improved.

The halide solid electrolyte may be represented by the following composition formula (A7).

Li_{3-3δ-a}Y_{1+δ-a}MeₐCl_{6-x-y}BrₓI_{y} formula (A7)

In the composition formula (A7), “Me” includes at least one selected from the group consisting of Zr, Hf, and Ti. “Me” may be at least one selected from the group consisting of Zr, Hf, and Ti. In the composition formula (A7), “δ”, “a”, “x” and “y” satisfy −1<δ<1, 0<a<1.5, 0<(3−3δ−a), 0<(1+δ−a), 0≤x≤6, 0≤y≤6, and (x+y)≤6. According to the configuration described above, the ion conductivity of the halide solid electrolyte may further be improved.

The halide solid electrolyte may be represented by the following composition formula (A8)

Li_{3-3δ-2a}Y_{1+δ-a}MeₐCl_{6-x-y}BrₓI_{y} formula (A8).

In the composition formula (A8), “Me” includes at least one selected from the group consisting of Ta, and Nb. “Me” may be at least one selected from the group consisting of Ta, and Nb. In the composition formula (A8), “δ”, “a”, “x” and “y” satisfy −1<δ<1, 0<a<1.2, 0<(3−3δ−2a), 0<(1+δ−a), 0≤x≤6, 0≤y≤6, and (x+y)≤6. According to the configuration described above, the ion conductivity of the halide solid electrolyte may further be improved.

Examples of the halide solid electrolyte may include Li₂YX₆, Li₂MgX₄, Li₂FeX₄, Li(Al, Ga, In)X₄, and Li₃(Al, Ga, In)X₆. In these materials, the element “X” is at least one selected from the group consisting of F, Cl, Br, and I. In the present disclosure, “(Al, Ga, In)” denotes at least one kind of the element selected from the element group in the parentheses. That is, “(Al, Ga, In)” is synonymous with “at least one kind selected from the group consisting of Al, Ga, and In”. The same applies to other elements.

“X” (that is, an anion) included in the halide solid electrolyte includes at least one selected from the group consisting of F, Cl, Br, and I, and may further include an oxygen. According to the configuration described above, the ion conductivity of the halide solid electrolyte may further be improved.

As described above, the halide solid electrolyte may be represented by composition formula (1). Further, the halide solid electrolyte may be a solid electrolyte represented by Li_{6-3A}M_{A}X₆, wherein “A” satisfies 0<A<2, “M” is at least one of Y and In, and “X” is at least one of Cl and Br.

In Li_{6-3A}M_{A}X₆, when “M” is at least one kind of Y and In, “A” is more than 0, may be 0.75 or more, and may be 1 or more. Meanwhile, “A” is less than 2, may be 1.5 or less, and may be 1.25 or less. It is preferable that “M” is at least one kind of Y and In, preferably includes at least Y, and may be Y only. “X” is at least one kind of Cl and Br, may be Cl only, may be Br only, and may be the both of Cl and Br.

The solid electrolyte represented by Li_{6-3A}M_{A}X₆ may include first crystal phase wherein the array of “X” is the same array as the array of Br in Li₃ErBr₆ including a crystal structure belonging to the space group C2/m. In this case, a typical peak is observed within a range wherein 2θ is respectively 25° to 28°, 29° to 32°, 41° to 46°, 49° to 55°, and 51° to 58°, in X-ray diffraction measurement using a CuKα ray. Also, when the peak intensity of the first crystal phase corresponding to (200) plane in the crystal structure of Li₃ErBr₆ is regarded as I₂₀₀, and the peak intensity of the first crystal phase corresponding to (110) plane is regarded as I₁₁₀, I₁₁₀/I₂₀₀≤0.01 may be satisfied. Also, when the half width of the peak of the first crystal phase corresponding to (200) plane in the crystal structure of Li₃ErBr₆ is regarded as FWHM₁, and the diffraction angle of the center of the peak (peak center value) is regarded as 2θc₁, FWHM₁/2θc₁≥0.015 may be satisfied.

The solid electrolyte represented by Li_{6-3A}M_{A}X₆ may include second crystal phase wherein the array of “X” is the same array as the array of Cl in Li₃ErCl₆ including a crystal structure belonging to the space group P-3m1. In this case, a typical peak is observed within a range wherein 2θ is respectively 29.8° to 32°, 38.5° to 41.7°, 46.3° to 50.4°, and 50.8° to 55.4°, in X-ray diffraction measurement using a CuKα ray. Also, when the peak intensity of the second crystal phase corresponding to (303) plane in the crystal structure of Li₃ErCl₆ is regarded as I₃₀₃, and the peak intensity of the second crystal phase corresponding to (110) plane is regarded as I′₁₁₀, I′₁₁₀/I₃₀₃≤0.3 may be satisfied. Also, when the half width of the peak of the second crystal phase corresponding to (303) plane in the crystal structure of Li₃ErCl₆ is regarded as FWHM₂, and the diffraction angle of the center of the peak (peak center value) is regarded as 2θc₂, FWHM₂/2θc₂≥0.015 may be satisfied.

The solid electrolyte represented by Li_{6-3A}M_{A}X₆ may include third crystal phase wherein the array of “X” is the same array as the array of Cl in Li₃YbCl₆ including a crystal structure belonging to the space group Pnma. In this case, a typical peak is observed within a range wherein 2θ is respectively 29.8° to 32°, 38.5° to 41.7°, 46.3° to 50.4°, and 50.8° to 55.4°, in X-ray diffraction measurement using a CuKα ray. Also, when the half width of the peak of the third crystal phase corresponding to (231) plane in the crystal structure of Li₃YbCl₆ is regarded as FWHM₃, and the diffraction angle of the center of the peak (peak center value) is regarded as 2θc₃, FWHM₃/2θc₃≥0.015 may be satisfied.

The solid electrolyte represented by Li_{6-3A}M_{A}X₆ wherein “X” includes at least Br, may include fourth crystal phase wherein a peak is observed within a range wherein 2θ is respectively 13.1° to 14.5°, 26.6° to 28.3°, 30.8° to 32.7°, 44.2° to 47.1°, 52.3° to 55.8°, and 54.8° to 58.5°, in X-ray diffraction measurement using a CuKα ray. Also, when the half width of the peak observed within a range wherein 2θ is 26.6° to 28.3° is regarded as FWHM₄, and the diffraction angle of the center of the peak (peak center value) is regarded as 2θc₄, FWHM₄/2θc₄≥0.015 may be satisfied. Also, when the peak intensity of the peak observed within a range wherein 2θ is 26.6° to 28.3° is regarded as I₁, and the peak intensity of the peak observed within a range wherein 2θ is 15.0° to 16.0° is regarded as I₂, I₂/I₁≤0.1 may be satisfied, and I₂/I₁≤0.01 may be satisfied. Incidentally, when a peak is not observed within a range wherein 2θ is 15.0° to 16.0°, I2=0.

The solid electrolyte represented by Li_{6-3A}M_{A}X₆ wherein “X” includes at least Cl, may include fifth crystal phase wherein a peak is observed within a range wherein 2θ is respectively 15.3° to 16.3°, 29.8° to 32°, 38.5° to 41.7°, 46.3° to 50.4°, and 50.8° to 55.4°, in X-ray diffraction measurement using a CuKα ray. Also, when the half width of the peak observed within a range wherein 2θ is 29.8° to 32° is regarded as FWHM₅, and the diffraction angle of the center of the peak (peak center value) is regarded as 2θc₅, FWHM₅/2θc₅≥0.015 may be satisfied. Also, when the peak intensity of the peak observed within a range wherein 2θ is 29.8° to 32° is regarded as I₃, and the peak intensity of the peak observed within a range wherein 2θ is 15.3° to 16.3° is regarded as I₄, I₄/I₃≤0.3 may be satisfied.

The halide solid electrolyte may be a chloride solid electrolyte. The chloride solid electrolyte is an electrolyte including at least a Cl element as the halogen element. The halide solid electrolyte may include the Cl element as a main component of the halogen element. The “main component of the halogen element” refers to a halogen element of the highest proportion in all the halogen elements included in the halide solid electrolyte. The proportion of the Cl element with respect to all the halogen elements included in the first solid electrolyte layer is, for example, 30 mol % or more, may be 50 mol % or more, may be 70 mol % or more, and may be 90 mol % or more.

The proportion of the halide solid electrolyte in the first solid electrolyte layer is, for example, 80 volume % or more, and may be 90 volume % or more. Also, the halide solid electrolyte may be obtained by, for example, carrying out a mechanical milling treatment to a raw material composition. When the raw material composition includes LiCl and YCl₃ at the molar ratio of LiCl:YCl₃=3:1, for example, a halide solid electrolyte represented by Li₃YCl₆ may be obtained by carrying out a mechanical milling treatment.

The first solid electrolyte layer may further include a binder. The binder may be in the same contents as those described in “1. Anode” above; thus, the description herein is omitted. The thickness of the first solid electrolyte layer is, for example, 0.1 μm or more and 500 μm or less.

(2) Second Solid Electrolyte Layer

The second solid electrolyte layer is a layer including at least a sulfide solid electrolyte as a solid electrolyte. The second solid electrolyte layer preferably includes the sulfide solid electrolyte as a main component of the solid electrolyte. The reason therefor is to improve the ion conductivity. The definition of “main component of the solid electrolyte” is as described above. The proportion of the sulfide solid electrolyte with respect to all the solid electrolyte in the second solid electrolyte layer is, for example, 50 volume % or more, may be 70 volume % or more, and may be 90 volume % or more.

Also, the second solid electrolyte layer may include only the sulfide solid electrolyte as a solid electrolyte. Meanwhile, when the second solid electrolyte layer includes the solid electrolyte other than the sulfide solid electrolyte, examples of the solid electrolyte may include inorganic solid electrolytes such as an oxide solid electrolyte, a nitride solid electrolyte, and a halide solid electrolyte. Also, the second solid electrolyte layer may not include the halide solid electrolyte. In this case, deterioration of performance due to the reductive decomposition of the halide solid electrolyte, may be prevented.

The sulfide solid electrolyte preferably includes Li M² (M² is at least one kind of P, As, Sb, Si, Ge, Sn, B, Al, Ga, and In), and S. Also, M² preferably includes at least P. Further, the sulfide solid electrolyte may further include at least one of O and halogen. Examples of the halogen may include F, Cl, Br, and I.

The sulfide solid electrolyte preferably includes an ion conductor including Li, P and S. The ion conductor preferably includes PS₄³⁻ structure as an anion structure. The proportion of the PS₄³⁻ structure with respect to all the anion structures in the ion conductor is, for example, 50 mol % or more, may be 70 mol % or more, and may be 90 mol % or more. The proportion of the PS4³⁻ structure may be determined by, for example, a Raman spectroscopy, NMR, and XPS.

The sulfide solid electrolyte preferably includes an ion conductor including Li, P, and S; and at least one of LiBr and LiI. At least a part of the LiBr and LiI preferably exist in a condition incorporated into the structure of the ion conductor as a LiBr component and a LiI component, respectively. The proportion of the LiBr and LiI included in the sulfide solid electrolyte is, for example, 1 mol % or more and 30 mol % or less, and may be 5 mol % or more and 20 mol % or less, respectively.

The sulfide solid electrolyte preferably has a composition represented by, for example, (100−a−b)(Li₃PS₄)−aLiBr−bLiI. The “a” may satisfy, for example, 1≤a≤30, and may satisfy 5≤a≤20. The “b” may satisfy, for example, 1≤b≤30, and may satisfy 5≤b≤20.

The sulfide solid electrolyte preferably includes a crystal phase (crystal phase A) having a peak at 2θ=20.2°±0.5°, and 23.6°±0.5°, in X-ray diffraction measurement using a CuKα ray. This is because the crystal phase A has high ion conductivity. The crystal phase A usually has a peak also at 2θ=29.4°±0.5°, 37.8°±0.5°, 41.1°±0.5°, and 47.0°±0.5°. Also, the half width of the peak at 2θ=20.2°±0.5° is preferably low. The half width (FWHM) is, for example, 0.51° or less, may be 0.45° or less, and may be 0.43° or less.

Although the sulfide solid electrolyte may include a crystal phase (crystal phase B) having a peak at 2θ=21.0°±0.5°, and 28.0°±0.5°, in X-ray diffraction measurement using a CuKα ray, the crystal phase B is preferably not included. This is because the crystal phase B has lower ion conductivity than the crystal phase A. The crystal phase B usually has a peak also at 2θ=32.0°±0.5°, 33.4°±0.5°, 38.7°±0.5°, 42.8°±0.5°, and 44.2°±0.5°. When the peak intensity of the peak at 2θ=20.2°±0.5° in crystal phase A is regarded as I_{20.2}, and the peak intensity of the peak at 2θ=21.0°±0.5° in crystal phase B is regarded as I_{21.0}, I_{21.0}/I_{20.2} is, for example, 0.4 or less, may be 0.2 or less, and may be 0.

The sulfide solid electrolyte may include a crystal phase such as thio-LISICON type crystal phase, LGPS type crystal phase, and argyrodite type crystal phase.

Examples of the shape of the sulfide solid electrolyte may include a granular shape. Also, the average particle size (D₅₀) of the sulfide solid electrolyte is, for example, 0.1 μm or more and 50 μm or less. The average particle size (D₅₀) may be determined from the result of a particle size distribution measurement by a laser diffraction/scattering method. Also, the ion conductivity of the sulfide solid electrolyte is preferably high. The ion conductivity at 25° C. is, for example, 1×10⁻⁴ S/cm or more, and may be 1×10⁻³ S/cm or more.

The sulfide solid electrolyte may be obtained by, for example, carrying out a mechanical milling treatment to a raw material composition including Li₂S and P₂S₅ to form a sulfide glass, and then, carrying out a heat treatment to the sulfide glass. The proportion of Li₂S with respect to the total of Li₂S and P₂S₅ in the raw material composition is, for example, 70 mol % or more, may be 72 mol % or more, and may be 74 mol % or more. Meanwhile, the proportion of Li₂S is, for example, 80 mol % or less, may be 78 mol % or less, and may be 76 mol % or less. The raw material composition may further include at least one of LiBr and LiI.

The second solid electrolyte layer may further include a binder. The binder may be in the same contents as those described in “1. Anode” above; thus, the description herein is omitted. The thickness of the second solid electrolyte layer is, for example, 0.1 μm or more and 500 μm or less.

(3) Solid Electrolyte Layer

The solid electrolyte layer in the present disclosure includes a first solid electrolyte layer, and a second solid electrolyte layer placed between the first solid electrolyte layer and the anode active material layer.

The solid electrolyte layer in the present disclosure may include only one layer, and may include two or more layers of the first solid electrolyte layer and the second solid electrolyte layer respectively. The first solid electrolyte layer may or may not be in contact with the cathode active material layer. The first solid electrolyte layer and the second solid electrolyte layer may or may not be in contact with each other. The second solid electrolyte layer may or may not be in contact with the cathode active material layer.

Also, when the thickness of the first solid electrolyte layer is regarded as T_{F}, and the thickness of the second solid electrolyte layer is regarded as T_{S}, T_{F} may be more than T_{S}, may be the same as T_{S}, and may be less than T_{S}. T_{F} being more than T_{S} means that the difference between T_{F} and T_{S} is more than 3 μm. In this case, a solid electrolyte layer with high ion conductivity may be obtained. T_{F} being the same as T_{S} means that the absolute value of the difference between T_{F} and T_{S} is 3 μm or less. In this case, a solid electrolyte layer with good balance between the ion conductivity and the safety against heating may be obtained. T_{F} being less than T_{S} means that the difference between T_{S} and T_{F} is more than 3 μm. In this case, a solid electrolyte layer with high safety against heating may be obtained.

3. Cathode

The cathode in the present disclosure includes a cathode active material layer, and a cathode current collector. The cathode active material layer is a layer including at least a cathode active material. Also, the cathode active material layer may include at least one of a conductive material, a solid electrolyte, and a binder, as necessary.

Examples of the cathode active material may include an oxide active material. Examples of the oxide active material may include rock salt bed type active materials such as LiCoO₂, LiMnO₂, LiNiO₂, LiVO₂, LiNi_{1/3}Co_{1/3}Mn_{1/3}O₂; spinel type active materials such as LiMn₂O₄, Li₄Ti₅O₁₂, and Li(Ni_{0.5}Mn_{1.5})O₄; and olivine type active materials such as LiFePO₄, LiMnPO₄, LiNiPO₄, and LiCoPO₄.

A protecting layer including a Li ion conductive oxide may be formed on the surface of the oxide active material. The reason therefor is to suppress the reaction between the oxide active material and the solid electrolyte. Examples of the Li ion conductive oxide may include LiNbO₃. The thickness of the protecting layer is, for example, 1 nm or more and 30 nm or less.

Examples of the shape of the cathode active material may include a granular shape. The average particle size (D₅₀) of the cathode active material is not particularly limited; and is, for example, 10 nm or more, and may be 100 nm or more. Meanwhile, the average particle size (D₅₀) of the cathode active material is, for example, 50 μm or less, and may be 20 μm or less.

The conductive material, the solid electrolyte, and the binder used for the cathode active material layer may be in the same contents as those described in “1. Anode” above; thus, the description herein is omitted. The thickness of the cathode active material layer is, for example, 0.1 μm or more and 1000 μm or less. Also, examples of the materials for the cathode current collector may include SUS, aluminum, nickel, iron, titanium, and carbon.

4. Battery

The battery in the present disclosure includes at least one power generation unit including a cathode active material layer, a solid electrolyte layer, and an anode active material layer, and may include two or more of them. When the battery includes a plurality of the power generation units, they may be connected in parallel, and may be connected in series. Incidentally, a battery using a solid electrolyte (particularly, inorganic solid electrolyte) instead of a liquid electrolyte corresponds to an all solid state battery.

FIG. 3 is a schematic cross-sectional view illustrating an example of a battery in the present disclosure, and is a schematic cross-sectional view illustrating a state wherein two power generation units are connected in parallel. Incidentally, in Example 1 described below, a battery having the structure shown in FIG. 3 was produced. Battery 10 shown in FIG. 3 comprises anode current collector 5; anode active material layer 4a, second solid electrolyte layer 3ya, first solid electrolyte layer 3xa, cathode active material layer 2a, and cathode current collector la placed in this order from one surface s1 of the anode current collector 5; and anode active material layer 4b, second solid electrolyte layer 3yb, first solid electrolyte layer 3xb, cathode active material layer 2b, and cathode current collector 1b placed in this order from another surface s2 of the anode current collector 5.

The battery 10 shown in FIG. 3 has the following advantages. That is, in a battery using an inorganic solid electrolyte such as a halide solid electrolyte and a sulfide solid electrolyte, the power generation unit is required to be pressed under extremely high pressure, in order to form good ion conductive path. Since the configuration of the other layers is symmetry with respect to the anode current collector 5 in the battery 10 shown in FIG. 3, generation of a stress to the anode current collector, due to the stretchability difference between the cathode active material layer and the anode active material layer, may be suppressed. Further, although not particularly shown in the figure, the battery in the present disclosure may have a structure wherein the configuration of the other layers is symmetry with respect to the cathode current collector.

The battery in the present disclosure is provided with an exterior body that houses a cathode, a solid electrolyte layer, and an anode. The kind of the exterior body is not particularly limited; and examples thereof may include a laminate exterior body.

The battery in the present disclosure may include a confining jig that applies a confining pressure to the cathode, the solid electrolyte layer and the anode, along the thickness direction. By applying the confining pressure, a favorable ion conductive path and an electron conductive path may be formed. The confining pressure is, for example, 0.1 MPa or more, may be 1 MPa or more, and may be 5 MPa or more. Meanwhile, the confining pressure is, for example, 100 MPa or less, may be 50 MPa or less, and may be 20 MPa or less.

The battery in the present disclosure is typically a lithium ion secondary battery. The use of battery is not particularly limited, and examples thereof may include a power supply of a vehicle such as a hybrid electric vehicle, a battery electric vehicle, a gasoline-powered vehicle, and a diesel-powered vehicle. In particular, it is preferably used in the driving power supply of a hybrid electric vehicle, or a battery electric vehicle. Also, the battery in the present disclosure may be used as a power source for moving objects other than vehicles, such as railroad vehicles, ships, and airplanes, or may be used as a power source for electric appliances such as information processing apparatuses.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Comparative Example 1

<Production of Anode Active Material>

Under Ar gas atmosphere, 0.65 g of Si particles (Kojundo Chemical Lab. Co., Ltd.) and 0.60 g of Li metal (Honjometal Corporation) were mixed in an agate mortar to obtain a LiSi precursor. 250 ml of ethanol (Nacalai Tesque, Inc.) at 0° C. was added to 1.0 g of the obtained LiSi precursor, and was reacted for 120 minutes in a glass reactor, under Ar gas atmosphere. Then, the liquid and the solid reactant were separated by a suction filtration, and the solid reactant was collected. To 0.5 g of the collected solid reactant, 50 ml of an acetic acid (Nacalai Tesque, Inc.) was added, and was reacted for 60 minutes in a glass reactor, under air atmosphere. Then, the liquid and the solid reactant were separated by a suction filtration, and the solid reactant was collected. The collected solid reactant was dried at 100° C. for two hours under vacuum to obtain an anode active material (nanoporous Si particles).

<Production of Anode>

The obtained anode active material (nanoporous Si particles, average particle size of 0.5 μm), a sulfide solid electrolyte (10LiI-15LiBr-75(0.75Li₂S-0.25P₂S₅) average particle size of 0.5 μm), a conductive material (VGCF-H), and a binder (SBR) were weighed so as the weight ratio was anode active material:sulfide solid electrolyte:conductive material:binder=47.0:44.6:7.0:1.4, and were mixed with a dispersing medium (di-isobutyl ketone). A slurry was obtained by dispersing the obtained mixture by an ultrasonic homogenizer (UH-50, from SMT Co., Ltd.). One surface of an anode current collector (a Ni foil, thickness of 22 μm) was coated with the obtained slurry by a blade coating method using an applicator, and was dried at 100° C. for 30 minutes. Then, another surface of the anode current collector was similarly coated and dried. Thereby, an anode including an anode current collector, and anode active material layers formed on both surfaces of the anode current collector, was obtained. The thickness of the anode active material layer (thickness of one surface) was 60 μm.

<Production of Member for Cathode>

A cathode active material (LiNi_{0.8}Co_{0.15}Al_{0.05}O₂, average particle size of 10 μm) coated with LiNbO₃ using a tumbling fluidized bed granulating-coating machine; a sulfide solid electrolyte (10LiI-15LiBr-75(0.75Li₂S-0.25P₂S₅), average particle size of 0.5 μm); a conductive material (VGCF-H); and a binder (SRB) were weighed so as the weight ratio was cathode active material:sulfide solid electrolyte:conductive material:binder=83.3:14.4:2.1:0.2, and were mixed with a dispersing medium (di-isobutyl ketone). A slurry was obtained by dispersing the obtained mixture by an ultrasonic homogenizer (UH-50, from SMT Co., Ltd.). An Al foil (thickness of 15 μm) was coated with the obtained slurry by a blade coating method using an applicator, and was dried at 100° C. for 30 minutes. Thereby, a member for a cathode including an Al foil and a cathode active material layer was obtained. The thickness of the cathode active material layer was 100 μm.

<Production of Member for Solid Electrolyte Layer>

A sulfide solid electrolyte (10LiI-15LiBr-75(0.75Li₂S-0.25P₂S₅), average particle size of 2.0 μm); and a binder (SBR) were weighed so as the weight ratio was sulfide solid electrolyte:binder=99.6:0.4, and were mixed with a dispersing medium (di-isobutyl ketone). A slurry was obtained by dispersing the obtained mixture by an ultrasonic homogenizer (UH-50, from SMT Co., Ltd.). An Al foil (thickness of 15 μm) was coated with the obtained slurry by a blade coating method using an applicator, and was dried at 100° C. for 30 minutes. Thereby, a member for a solid electrolyte layer including an Al foil and a solid electrolyte layer was obtained. The thickness of the solid electrolyte layer was 50 μm.

<Production of Battery>

Firstly, the anode and the member for a solid electrolyte layer were cutout into a size of 7.2 cm×7.2 cm. Meanwhile, the member for a cathode was cutout into a size of 7.0 cm×7.0 cm.

Next, the solid electrolyte layer of the member for a solid electrolyte layer was brought into contact with the anode active material layer located on one surface of the anode, and the solid electrolyte layer of the member for a solid electrolyte layer was also brought into contact with the anode active material layer located on another surface of the anode. The obtained stacked body was pressed under line pressure of 1.6 t/cm by a roll pressing method. Next, the Al foils were peeled off from the respective solid electrolyte layers to expose the solid electrolyte layers.

Then, the cathode active material layers of the member for a cathode were brought into contact with the respective exposed solid electrolyte layers. The obtained stacked body was pressed under line pressure of 1.6 t/cm by a roll pressing method. Next, the Al foils were peeled off from the respective cathode active material layers to expose the cathode active material layers, and further pressed under line pressure of 5 t/cm by a roll pressing method. Next, cathode current collectors (Al foils, thickness of 15 μm) including a carbon coating layer were respectively placed on the roll pressed cathode active material layers. Incidentally, the carbon coating layer was formed by weighing a conductive material (furnace black, from Tokai Carbon Co., LTD.); and a PVDF (Kureha corporation) so as the volume ratio was conductive material:binder=85:15, and mixing these with N-methyl pyrrolidone (NMP) to obtain a slurry, and coating the cathode current collector (Al foil) with the slurry and drying. Then, a tab for a current collector was provided on the cathode current collector and the anode current collector respectively, and laminate sealed to obtain a battery.

### Comparative Example 2

<Production of Member for Solid Electrolyte Layer>

A halide solid electrolyte (Li₃YBr₂Cl₄, average particle size of 0.5 μm); and a binder (SEBS) were weighed so as the weight ratio was halide solid electrolyte:binder=100:3, and were mixed with a dispersing medium (tetralin and p-chlorotoluene). A slurry was obtained by dispersing the obtained mixture by an ultrasonic homogenizer (UH-50, from SMT Co., Ltd.). An Al foil (thickness of 15 μm) was coated with the obtained slurry by a blade coating method using an applicator, and was dried at 100° C. for 30 minutes. Thereby, a member for a first solid electrolyte layer including an Al foil and a first solid electrolyte layer was obtained. The thickness of the first solid electrolyte layer was 25 μm.

Also, a sulfide solid electrolyte (10LiI-15LiBr-75(0.75Li₂S-0.25P₂S₅), average particle size of 2.0 μm); and a binder (SBR) were weighed so as the weight ratio was sulfide solid electrolyte:binder=99.6:0.4, and were mixed with a dispersing medium (di-isobutyl ketone). A slurry was obtained by dispersing the obtained mixture by an ultrasonic homogenizer (UH-50, from SMT Co., Ltd.). An Al foil (thickness of 15 μm) was coated with the obtained slurry by a blade coating method using an applicator, and was dried at 100° C. for 30 minutes. Thereby, a member for a second solid electrolyte layer including an Al foil and a second solid electrolyte layer was obtained. The thickness of the second solid electrolyte layer was 50 μm.

<Production of Battery>

An anode and a member for a cathode were prepared in the same manner as in Comparative Example 1. The anode, the member for a first solid electrolyte layer, and the member for a second solid electrolyte layer were cutout into a size of 7.2 cm×7.2 cm. Meanwhile, the member for a cathode was cutout into a size of 7.0 cm×7.0 cm.

The second solid electrolyte layer of the member for a second solid electrolyte layer was brought into contact with the anode active material layer located on one surface of the anode, and the second solid electrolyte layer of the member for a second solid electrolyte layer was also brought into contact with the anode active material layer located on another surface of the anode. The obtained stacked body was temporary pressed by a roll pressing method, the Al foils were peeled off from the respective second solid electrolyte layers to expose the second solid electrolyte layers. Then, the first solid electrolyte layers of the member for a first solid electrolyte layer were brought into contact with the respective exposed second solid electrolyte layers. The obtained stacked body was pressed under line pressure of 1.6 t/cm by a roll pressing method. Next, the Al foils were peeled off from the respective first solid electrolyte layers to expose the first solid electrolyte layers. Then, the cathode active material layers of the member for a cathode were brought into contact with the respective exposed first solid electrolyte layers. The obtained stacked body was pressed under line pressure of 1.6 t/cm by a roll pressing method. After that, a battery was obtained by carrying out similar processes as in Comparative Example 1.

### Comparative Example 3

LTO particles (Li₄Ti5₂O₁₂, average particle size of 0.7 μm); and a binder (SBR) were weighed so as the weight ratio was LTO particles:binder=95:5, and were mixed with a dispersing medium (di-isobutyl ketone). A slurry was obtained by dispersing the obtained mixture by an ultrasonic homogenizer (UH-50, from SMT Co., Ltd.). One surface of an anode current collector (Ni foil, thickness of 22 μm) was coated with the obtained slurry by a blade coating method using an applicator, and was dried at 100° C. for 30 minutes. After that, another surface of the anode current collector was similarly coated and dried. Thereby, an anode current collector including a coating layer on both surfaces was obtained. The thickness of the coating layer (thickness of one surface) was 5 μm. A battery was obtained in the same manner as in Comparative Example 1 except that the obtained anode current collector was used.

### Example 1

An anode current collector including a coating layer on both surfaces was obtained in the same manner as in Comparative Example 3. A battery was obtained in the same manner as in Comparative Example 2 except that the obtained anode current collector was used.

[Evaluation]

<Nailing Test>

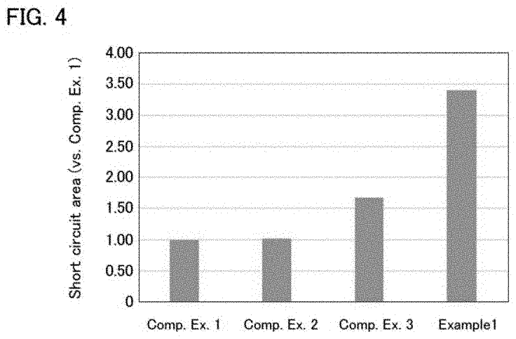

The batteries obtained in Example 1 and Comparative Examples 1 to 3 were charged, and a nailing test was carried out. Specifically, the battery was constant-size confined under 5 MPa, and a constant current charge (current value of ⅓ C, charge termination voltage of 4.05 V), and a constant voltage charge (voltage value of 4.05 V, current value of 20 A) were carried out. During the constant voltage charge, an iron nail with a diameter of 3.0 mm and tip angle of 30° was inserted from the side surface of the battery, at rate of 0.1 mm/sec, so as to generate an internal short circuit. After that, the nail was kept inserted until the battery temperature reached at 300° C., and the short circuit area at that time was measured. The “short circuit area” referrers to the cross-sectional area of a hole generated by penetration of the nail. Since the nail tip was angled, the short circuit area increases by inserting the nail deeper. The short circuit area was calculated by observing the size of the hole generated in the battery after the nailing test, with a microscope. The results are shown in Table 1 and FIG. 4. Incidentally, the short circuit area is a relative value when the result in Comparative Example 1 is regarded as 1.00.

TABLE 1

| | | | Short circuit area |
|---|---|---|---|
| | Coating layer | Solid electrolyte layer | (relative value) |
| Comp. Ex. 1 | No | Sulfide solid electrolyte | 1.00 |
| Comp. Ex. 2 | No | Sulfide solid electrolyte | 1.02 |
| | | Halide solid electrolyte | |
| Comp. Ex. 3 | Yes | Sulfide solid electrolyte | 1.68 |
| Example 1 | Yes | Sulfide solid electrolyte | 3.40 |
| | | Halide solid electrolyte | |

As shown in Table 1 and FIG. 4, compared to Comparative Examples 1 to 3, the short circuit area in Example 1 was large. Specifically, with respect to Comparative Example 1, the short circuit area in Comparative Example 2 was at a comparable level, and the short circuit area was slightly increased in Comparative Example 3. In contrast to this, it was confirmed that the result in Example 1 was drastically improved with respect to Comparative Example 1. It is surmised that this was a synergistic effect obtained because the coating layer blocked the sneak current during short circuit, while the halide solid electrolyte exhibited good heat stability.

### REFERENCE SIGNS LIST

1 . . . cathode current collector
2 . . . cathode active material layer
3 . . . solid electrolyte layer
4 . . . anode active material layer
5 . . . anode current collector
6 . . . coating layer
10 . . . battery

What is claimed is:

1. A battery comprising a cathode current collector, a cathode active material layer, a solid electrolyte layer, an anode active material layer, and an anode current collector, in this order along a thickness direction, and
the anode current collector includes a coating layer including an oxide active material, on a surface of the anode active material layer side,
the solid electrolyte layer includes a first solid electrolyte layer, and a second solid electrolyte layer placed between the first solid electrolyte layer and the anode active material layer,
the first solid electrolyte layer includes a halide solid electrolyte, and
the second solid electrolyte layer includes a sulfide solid electrolyte.

2. The battery according to claim 1, wherein the oxide active material includes at least one of a lithium titanate, and a niobium titanium based oxide.

3. The battery according to claim 1, wherein the halide solid electrolyte is represented by the following composition formula (1),
Li_{α}M_{β}X_{γ} formula (1),
α, β, and γ are respectively a value more than 0,
“M” includes at least one selected from the group consisting of a metal element other than Li, and a metalloid element, and
“X” includes at least one selected from the group consisting of F, Cl, Br, and I.

4. The battery according to claim 3, wherein the halide solid electrolyte is represented by Li_{6-3A}M_{A}X₆, wherein “A” satisfies 0<A<2, “M” is at least one of Y and In, and “X” is at least one of Cl and Br.

5. The battery according to claim 1, wherein the halide solid electrolyte is a chloride solid electrolyte.

6. The battery according to claim 1, wherein the sulfide solid electrolyte includes Li, P, and S.

7. The battery according to claim 1, wherein the anode active material layer includes an anode active material whose total volume expansion rate, due to charge, is 14% or more.

8. The battery according to claim 1, wherein an anode active material is a Si based active material.

9. The battery according to claim 1, wherein a ratio of a thickness of the coating layer with respect to a thickness of the anode active material layer is 3% or more and 20% or less.
